(19) United States
(12) Patent Application Publication
(10) Pub. No.: US 2012/0240327 A1
(43) Pub. Date: Sep. 27, 2012

(54) HOLDER APPARATUS

(75) Inventor: Robert W. Stimpson, Douglas (IM)

(73) Assignee: DLP LIMITED, Douglas (IM)

(21) Appl. No.: 13/512,960

(22) PCT Filed: Dec. 11, 2009
(86) PCT No.: PCT/GB09/51700

§ 371 Date: May 31, 2012

(30) Foreign Application Priority Data
Dec. 11, 2009 (GB) PCT/GB2009/051700

(51) Int. Cl. E03C 1/06; F16M 13/02

(52) U.S. Cl. 4/605; 248/276.1

(57) ABSTRACT

A holder apparatus, preferably for a shower head, which includes an elongate holder bar that is rotatable about its longitudinal axis, a holder element that is keyed to the holder bar for slidable movement along the holder bar, an adjustment mechanism for rotating the holder bar so as to alter a pan position of the holder element, and a locking mechanism for positively and releasably locking the holder bar in place so as to prevent or limit rotation. The adjustment mechanism may have a controller at, or adjacent to, one end of the holder bar that is operable by a user to adjust an angular position of the holder bar. The holder bar may also function as a fixed and secure grab bar when used in conjunction with the locking mechanism.

### FIELD

This invention relates to a remotely controllable holder apparatus and more particularly relates to a showerhead holder apparatus that may also function as a rigid and stable handrail.

### BACKGROUND

A shower installation may be shared by both able-bodied and disabled or infirm users in a multiple occupancy building, such as a home A disabled or infirm user, however, may be restricted to a shower seat or shower wheel chair. In these cases, the showerhead is frequently placed out of reach of the seated users by the able-bodied users. Similarly, young children may find it difficult to reach and replace a shower head slidably mounted on a riser and riser rail device.

Further, a riser-rail of a showerhead holder device is usually flimsy and not intended or designed to take the weight of a user bearing against it. For an elderly or infirm user, however, particularly one who showers in a seated position, a riser-rail may be conveniently positioned for grabbing to allow a user to pull themself upright.

More generally, it would also be beneficial to provide a device holder that may be manipulated remotely. A remotely manipulated device holder would have applications in a wide variety of industries.

Additionally, it would be advantageous to reduce production costs by cross-utilizing parts from one kind of apparatus in another kind of apparatus.

The present invention seeks to provide a solution to these problems.

### SUMMARY

From the foregoing discussion, it should be apparent that a need exists for a holder apparatus. The present invention has been developed in response to the present state of the art, and in particular, in response to the problems and needs in the art that have not yet been fully solved. Accordingly, the present invention has been developed to provide a holder apparatus that overcomes many or all of the above-discussed shortcomings in the art.

In the following description, the pan action is defined here as rotation in a generally horizontal plane about a typically vertical axis. The term is commonly applied to such movements within the closed-circuit television industry.

According to a first embodiment of the invention, there is a holder apparatus that includes an elongate holder bar that is rotatable about its longitudinal axis, a holder element that is keyed to the holder bar for slidable movement along the holder bar, an adjustment mechanism for rotating the holder bar so as to alter a pan position of the holder element, the adjustment mechanism having a controller that is operable by a user to adjust an angular position of the holder bar, the controller being at or adjacent to one end of the holder bar, and a locking mechanism for positively and releasably locking the holder bar in place so as to prevent or limit rotation whereby the holder bar may be utilized as a fixed grab bar.

Preferable and/or optional features of the first aspect of the invention are set forth in claims 2 to 18, inclusive.

According to a second embodiment of the invention, there is provided a shower installation having a holder apparatus in accordance with the first embodiment of the invention, and a showerhead that is releasably engageable with the holder element and remotely movable in at least a pan direction by the adjustment mechanism of the holder apparatus.

According to a third embodiment of the invention, there is provided an installation having a holder apparatus in accordance with the first embodiment of the invention, and an item that is holdable by the holder element and remotely movable in at least a pan direction by the adjustment mechanism of the holder apparatus.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view of one embodiment of holder apparatus, in accordance with the present invention;

FIG. 2 is a perspective longitudinal cross-sectional view through a controller, lower adapter and lower wall-mounting bracket of the holder apparatus;

FIG. 3 is a side elevational view of the portion of the holder apparatus shown in FIG. 2;

FIG. 4 is a side elevational longitudinal cross-sectional view of an upper adapter element and upper wall-mounting bracket of the holder apparatus;

FIG. 5 shows a perspective view of the upper adapter element in isolation;

FIG. 6 shows the controller of the holder apparatus in isolation and in a first condition;

FIG. 7 shows the controller of the holder apparatus in isolation and in a second condition;

FIG. 8 shows a perspective view of a spacer element of the holder apparatus, in a first condition and shown in isolation; and

FIG. 9 shows the aforementioned spacer element in a second condition

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Referring to the drawings, there is shown a first embodiment of the holder apparatus 10 that, in this case, is adapted to hold a showerhead and includes an elongate riser rail or bar 12 vertically fixed to a supporting surface via lower and upper wall-mounting brackets 14, 16, a showerhead riser 18 that is slidably mounted to the riser bar 12, an adjustment mechanism 20 for adjusting a position of the riser 18 relative to the upper and lower brackets 14, 16, and a locking mechanism 22 for releasably locking the riser bar 12 in place.

The riser bar 12, in this case, comprises an elongate rigid-metal tubular inner support element 24 and an elongate resilient plastic outer sleeve 26 that extends to, or adjacent to, the ends of the inner support element 24. Other material, such as plastic, may be considered for the inner support element 24. Furthermore, the inner support element 24 may be solid or hollow along its entire longitudinal extent. In this embodiment, the riser bar 12 has a straight or rectilinear longitudinal extent, but it may also be curved.

The outer sleeve 26 preferably includes a plurality of shallow channels or flutes 28 of uniform, or substantially uniform, lateral cross-sections along their longitudinal extent. Each flute 28 extends in parallel with the other flutes 28 and with the longitudinal axis of the riser bar 12. In this case, the flutes 28 are equi-angularly spaced about the circumference of the outer sleeve 26. The showerhead riser 18 may also be keyed to the flutes 28, as will be described below. Although the holder bar in this case is provided with an outer sleeve, the holder bar may consist of one piece, such as an aluminum extrusion.

The riser bar 12 may conveniently be used as a grab rail or holder bar for fixed stationary mounting typically on a wall surface, either in a shower installation or around a home or other building, to assist a user requiring additional support during movement. The holder bar 12 is thus multi-functional and is incorporated in this invention to be used not only as a grab rail, but also as a riser bar.

The upper and lower wall-mounting brackets 14, 16 may also be utilized as part of the grab rail apparatus, whereby the holder bar 12 may be secured to a wall surface at the shower installation or around the home or other building. The upper and lower brackets 14, 16 include a wall-abutting, mounting flange 30, an elbow element 32 that extends from the flange 30, and a socket 34 at the distal end of the elbow element 32 remote from the flange 30. An optional releasable flange cover 36 may also be included to cover the heads of fasteners used to secure the flange 30 to a mounting surface.

The socket 34 of each bracket 14, 16 may be ribbed or corrugated to complimentarily engage ends of the fluted outer sleeve 26 of the holder bar 12, thereby preventing rotation when used solely as a dedicated grab rail.

In this embodiment, a lower adapter element 38 includes a boss 40, which is slidably received in the socket 34 of the lower bracket 14, and an axially facing toothed ring 42 on an adapter flange 44 that is seated on an edge of the socket 34. An exterior surface of the boss 40 includes ribs or corrugations for complementary engagement with the ribs or corrugations within the socket 34, thereby preventing or limiting relative angular displacement. One skilled in the relevant art will recognize other engagement shapes or means to prevent relative angular displacement.

The toothed ring 42 of the lower adapter is, or is similar to, a crown gear. The teeth 46, however, are generally castellations that have a very acute or even perpendicular flank angle.

The lower adapter element 38 also includes a raised biasing head 48 that protrudes from the plane of the toothed ring 42 and is coaxial with the holder bar 12. The biasing head 48 has a sloped or ramped undercut 50 from, or adjacent to, its upper edge to, or substantially to, the plane of the toothed ring 42.

A control housing 52 of the adjustment mechanism 20 is seated on the lower adapter element 38 and is rotatable relative to the control housing 52. The control housing 52 has upper and lower parts 54, 56 providing a cavity 58 therein, and presents a part spherical to the outer surface. The lower part 54 includes a generally cylindrical depending skirt 60 that covers the toothed ring 42 and partly overlies the outer surface of the lower bracket 14.

The upper part 56 includes a generally cylindrical wall 62 that projects upwardly to receive an end of the holder bar 12. An inner surface of the wall 62 is again ribbed or corrugated to provide complementary engagement with the outer sleeve 26 of the holder bar 12 so that the control housing 52 is angularly fixed relative to the holder bar 12.

The adjustment mechanism 20 also includes a controller 64 that in this embodiment is solely a mechanical control mechanism that is manually operable. The locking mechanism 22 mentioned above is also incorporated into the control mechanism. The controller 64 comprises a rigid elongate lever 66 that projects externally away from the control housing 52. The lever 66 in this case is slightly dished and generally oval, or in other words, paddle-shaped. The lever 66 may thus also function as a showering-accessory platform, such as for supporting soap. Optionally, at least one depending protrusion 68 is provided at or adjacent to a distal edge of the lever 66, which may aid operation by a user with limited or no dexterity.

The lever 66 is pivotably interconnected to the control housing 52 via a pivot axle 70. The pivot axle 70 is rigid so that when rotated in a horizontal plane by the lever 66, the control housing 52 is rotated. This arrangement rotates the holder bar 12 generally about the axis of the depending skirt 60 due to the keying between the upper part 56 of the control housing 52 and the outer sleeve 26 of the holder bar 12.

The pivot axle 70 includes a locking element 72 partway along the axle. The cavity 58 of the control housing 52 is dimensioned to receive the axle 70. The locking element 72 includes an arcuate locking pawl 74 on an underside thereof. The locking pawl 74 is coaxially, or substantially coaxially, aligned with the toothed ring 42 and includes teeth 76 that are complementarily shaped to enable interdigitation with the toothed ring 42 of the lower adapter element 38.

The locking element 72 also includes biasing means for biasing the locking pawl 74 into positive engagement with the toothed ring 42. The biasing means includes an upper cantilever arm 78. The locking element 72 also includes a lower cantilever arm 80. The cantilever arms 78, 80 are integrally formed as one-piece with a body 82 of the locking element 72. The upper cantilever arm 78 extends upwardly from the body 82 and into a bore 84 of the holder bar 12. A longitudinal extent of the upper cantilever arm 78 is put under tension by flexing, whereby a distal free end of the upper cantilever arm 78 is urged against an interior surface of a bore 84 of the holder bar 12. The flexing is such that a turning moment is constantly applied to the locking body 82 about the pivot axis of the axle 70 such that the at-rest locking pawl 74 is urged into engagement with the toothed ring 42.

The lower cantilever arm 80 may supplement the biasing of the upper cantilever arm 78 to provide a failsafe. The lower cantilever arm 80 hooks under the biasing head 48 of the lower adapter element 38 and is complementarily angled to ride along the undercut 50 thereof, which may be spherically sloped or ramped. Although not in this embodiment, the angle of the lower cantilever arm 80 may be such that a further turning moment, which is in the same angular direction as the first said turning moment imparted by the upper cantilever arm 78, may be applied about the pivot axis to the body 82 of the locking element 72, whereby the at-rest locking pawl 74 is urged into engagement with the toothed ring 42. In this embodiment, only the upper cantilever arm 78 flexes to impart the turning moment. Although the lower cantilever arm 80 may be optional, having a level of redundancy is preferable, due to the profile of the user likely to be operating the apparatus 10. Consequently, in a normal at-rest condition, the holder bar 12 is prevented from rotating by its engagement with the control housing 52 and the locking mechanism 22.

An upper adapter element 86 has a boss portion 88 that is slidably receivable as a close fit in the socket 34 of the upper bracket 16 and a socket portion 92 that is seated on an edge of the said socket 34. An exterior surface of the boss portion 88 is smooth to allow rotation in the socket 34. An interior surface of the socket portion 92 includes ribs or corrugations for complementary engagement with the flutes 28 of the outer sleeve 26 of the holder bar 12, thereby preventing or limiting relative angular displacement between the holder bar 12 and the upper adapter element 86. Again, other engagement shapes or means to prevent relative angular displacement may be considered.

The boss portion 88 includes a biasing element 94 that is generally a cantilevered arm member having a reduced-thickness body portion 96 and an enlarged head 98 at a distal free end thereof. The enlarged head 98 projects slightly beyond an exterior surface of the boss portion 88 and acts as a friction wiper when the boss portion 88 is received in the socket 34. The biasing element 94 consequently prevents or limits movement between the upper adapter element 86 and the socket 34 of the upper bracket 16.

The showerhead riser 18 includes a riser body 100 and a showerhead holder 102 that is rotatably mounted to the riser body 100. The riser body 100 includes a riser-rail aperture 104 that includes components of an internal, spring-loaded, button-operated mechanism 140. The mechanism 140 includes ribs or corrugations for complementary engagement with the flutes 28 of the outer sleeve 26 of the holder bar 12. In this arrangement, the riser body 100 is keyed to the holder bar 12, allowing manual, slidable movement along the longitudinal extent, while being angularly fixed, or substantially fixed, relative to the holder bar 12 in a circumferential direction, unless urged by application of force to the spring-backed, manually-operated button 140.

The showerhead holder 102 includes a generally C-shaped holder portion 108 that typically has a slight taper along its longitudinal extent. The holder portion 108 may releasably engage a generally frusto-conical shower-hose ferrule connected to a showerhead.

When the locking pawl 74 and the toothed ring 42 of the locking mechanism 22 are engaged, the holder bar 12 may be safely used as a grab rail. In this arrangement, the control housing 52 is locked relative to the upper and lower brackets 14, which prevents the holder bar 12 and the showerhead riser 18 from rotating. A user may thus use the grab rail to raise, lower, or steady themselves with little or no risk that the holder bar 12 will rotate.

To adjust a pan position of the holder portion 108 of the showerhead riser 18, the lever 66 of the adjustment mechanism 20 is first lifted. This lifting movement rotates the body 82 of the locking element 72 against the urging force of the upper cantilever arm 78. The lower cantilever arm 80 is engaged with the head element 50, which prevents or limits lifting of the control housing 52 away from the lower adapter element 38. The rotation of the body 82 raises the locking pawl, 74 causing disengagement from the toothed ring 42 of the lower adapter element 38. The user may then swing the lever 66 in the circumferential direction of the holder bar 12, typically being to the left or right of the user, causing the control housing 52 and the attached holder bar 12 to rotate. Because the showerhead riser 18 is angularly fixed relative to the holder bar 12, the showerhead riser 18 rotates and the pan position of the holder portion 108 may be remotely adjusted.

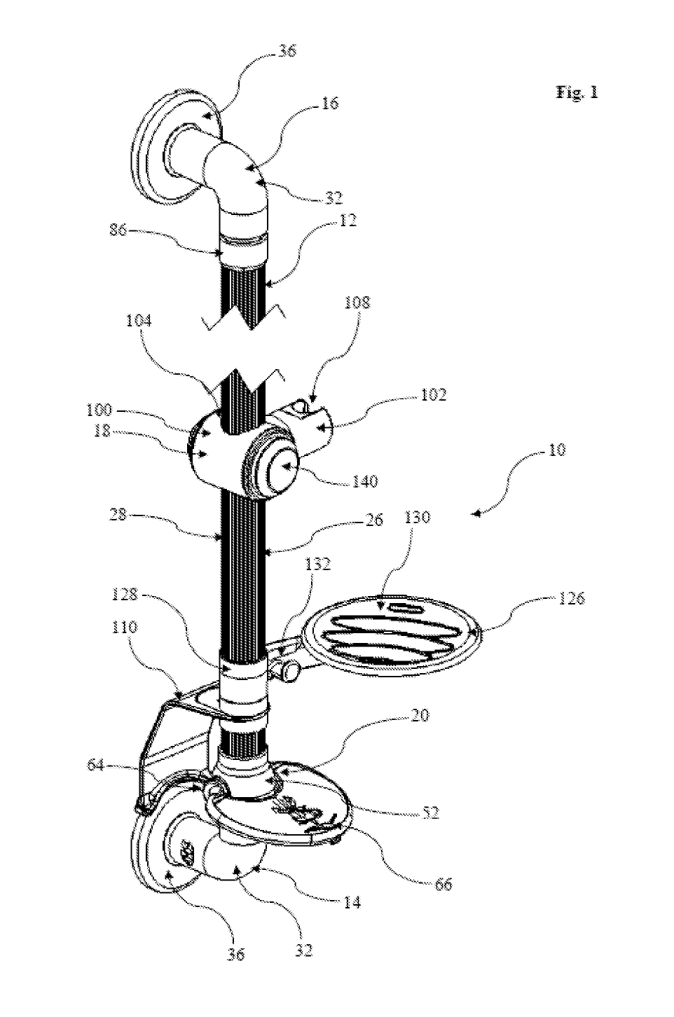

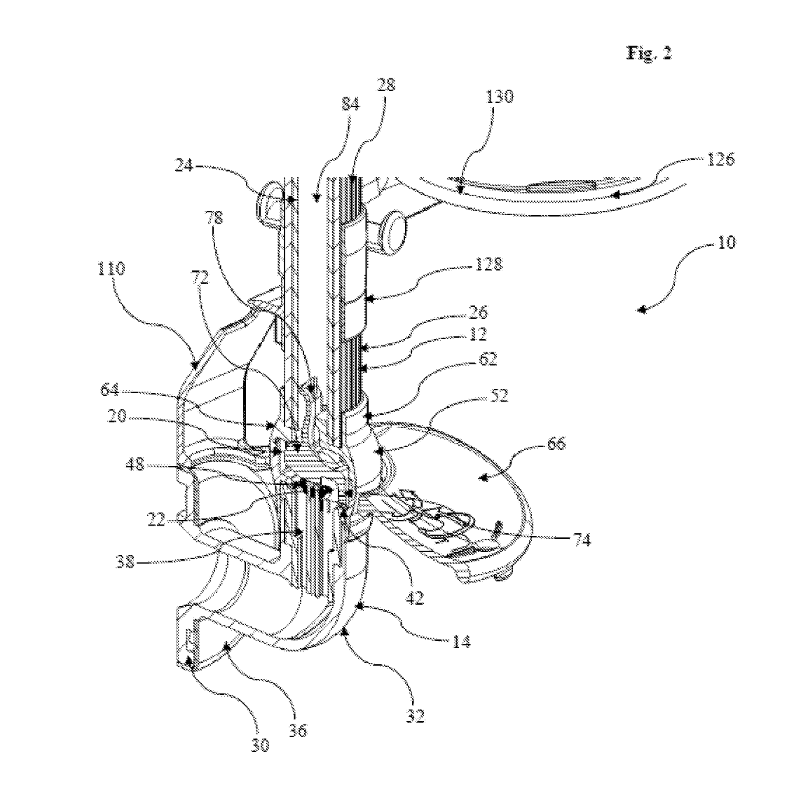

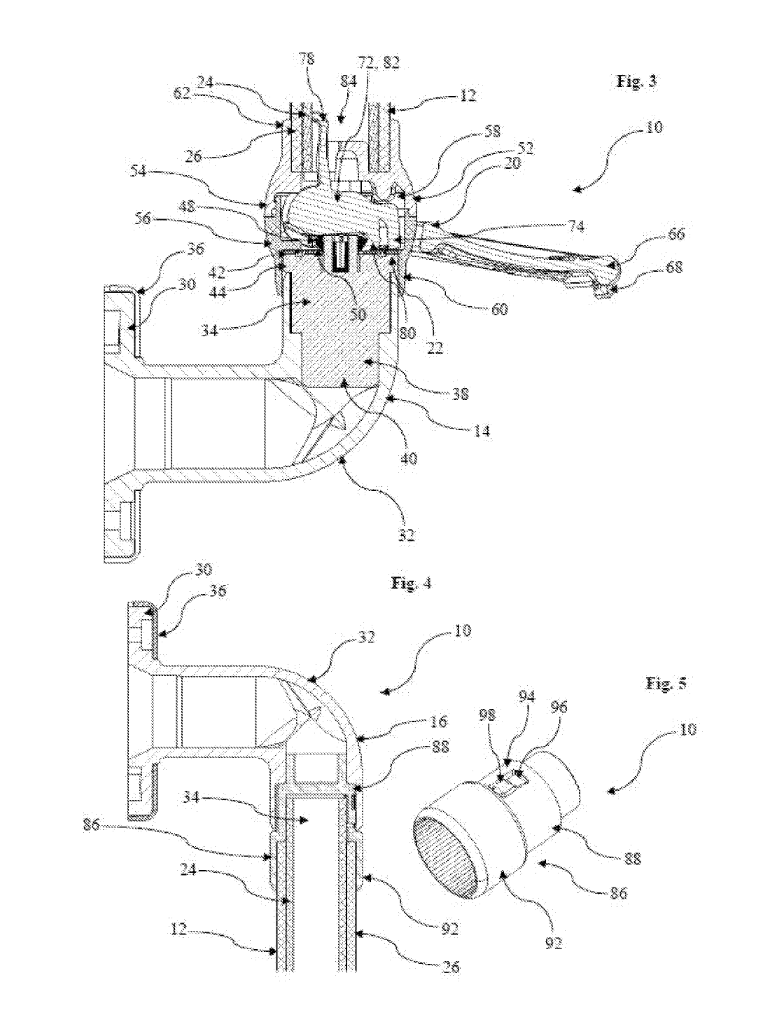

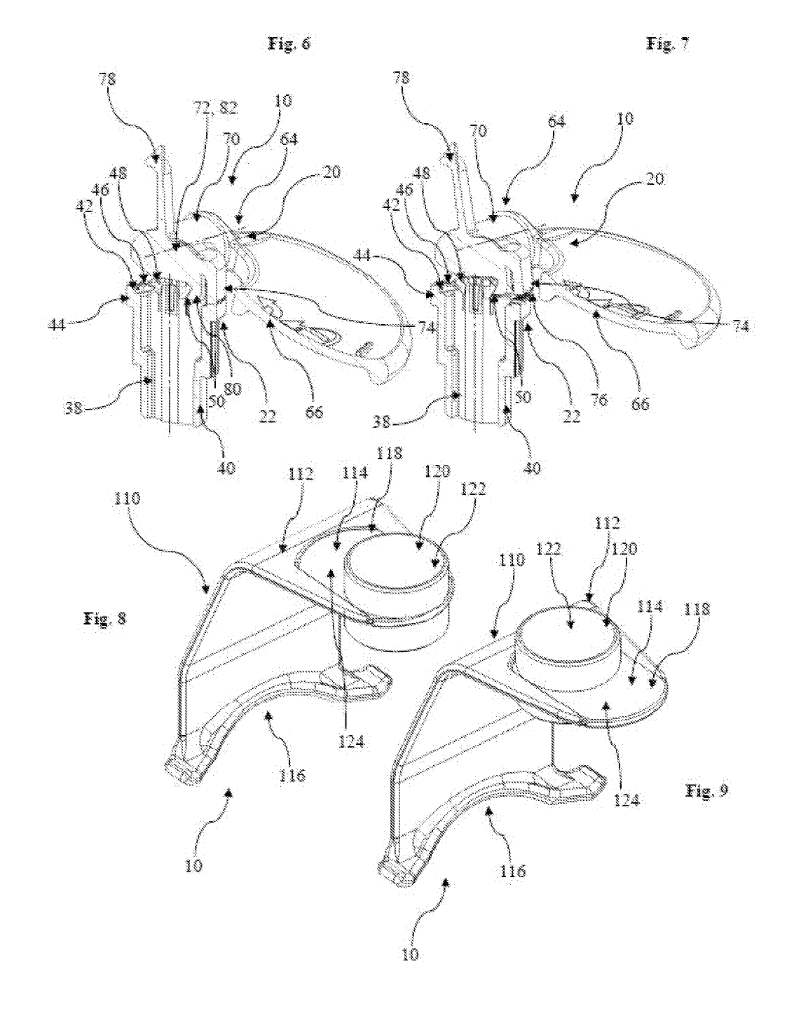

To stop the shower-head riser 18 from being slid too low towards the control housing 52, and/or to stop an accessory holder from sliding too far down, a spacer element 110 may be provided as best shown in FIGS. 1, 8 and 9. The spacer element 110 includes an angled arm member 112 that is seatable on the flange cover 36 of the lower wall-mounting bracket 14, and a collar element 114 through which the holder bar 12 is slidably and rotatably receivable.

The angled arm member 112 is rigid, and typically formed of molded plastics. The angled arm member 112 includes an arcuate flange recess 116 at one end that is complementarily shaped to receive an edge of the flange cover 36, and a collar recess 118 at the other end to releasably receive the collar element 114.

The collar element 114 is typically formed of molded plastics and includes a cylindrical collar portion 120, which has a smooth bore 122, and a collar flange 124, which is complimentarily shaped for engagement in the collar recess 118 of the arm member 112. The collar portion 120 is offset relative to the collar flange 124, whereby the collar element 114 may be positioned in two different, snap-fittedly retained orientations within the collar recess 118. This allows adaptation depending on the kind of upper and lower wall-mounting brackets utilized and the distance of their respective sockets from their mounting flanges.

A showering-accessory support element 126 is also provided in this embodiment, as can be seen in FIG. 1. This support element 126 includes a support collar 128 that is slidably and rotatably receivable on the holder bar 12, typically above the spacer element 110, and a platform element 130 attached to the support collar 128 via an adjustable arm portion 132. The platform element 130 may have a slightly dished and/or undulating upper surface to retain a showering accessory, such as soap, and may include one or more hooks and/or drainage apertures. In this case, the spacer element 110 functions as a stop for the showering-accessory support element 126.

Although the adjustment mechanism described above enables adjustment of only a pan position of the showerhead riser, the adjustment mechanism may also be adapted to adjust the tilt of the holder portion, and/or the position of the showerhead riser along the longitudinal extent of the holder bar. In this modified arrangement, the locking mechanism would still be provided.

Although only one particular locking mechanism of the locking means has been described above, one skilled in the art may envisage other releasable locking mechanisms. Similarly, only one particular adjustment mechanism of the adjustment means has been described above, but one skilled in the art may easily envisage other adjustment mechanisms. Even though the locking mechanism is largely integrated with the adjustment mechanism, the two mechanisms could be separate, and it is feasible that they could be operated independently of each other.

Although the holder apparatus described above is preferably for use with a showerhead holder or riser, it may also be envisaged by one skilled in the art that the apparatus may be conveniently motorized or remotely actuated with suitable driving elements positioned on the key rotational axes. This permits power-assisted, remote, or simultaneous control and operation of the apparatus by a caregiver who may stand outside the showering area and be able to control the showerhead position in conjunction with, or independent of, the bather.

The preceding description of a showerhead holder device may therefore be applied by those skilled in the art to the more general control of other devices such as spray heads for paint spraying and other liquid applicators, mechanical manipulation devices, or remote control of toxic or hazardous elements or manipulation devices. This may be accomplished by locating the adjustment mechanism on one side of a sealed or otherwise protective barrier, region, or room and passing the holder bar through the sealed barrier, region, or room such that the holder element and the actuated device are solely within that barrier, region, or room. Such an arrangement may necessitate the addition of sealing elements around mutually cooperating rotational surfaces (not shown). In this case, the holder element may take any suitable or necessary shape or form in order to engage, hold, or support the device, element, or equipment to be moved.

Therefore, it is possible to provide a remotely controllable holder apparatus that may be easily adjusted to a suitable pan position. It is also possible to provide a holder apparatus for holding a spray head, such as a showerhead, which enables either manual or motorized remote adjustment of the head to a suitable pan position by a seated or smaller-bodied user, as well as an able-bodied or standing adult. The incorporation of a grab bar for use as the riser-rail, along with an automatic and releasable locking mechanism, enables existing parts to be used in new applications while providing a showerhead riser that may double as a secure and fixed grab bar.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. Holder apparatus (10) comprising an elongate holder bar (12) which is rotatable about its longitudinal axis, a holder element (18) which is keyed to the holder bar (12) for slidable movement therealong, adjustment means (20) for rotating the holder bar (12) so as to alter a pan position of the holder element (18), the adjustment means (20) having a controller (64) which is operable by a user to adjust an angular position of the holder bar (12), the controller (64) being at or adjacent to one end of the holder bar (12), and locking means (22) for positively and releasably locking the holder bar (12) in place so as to prevent or limit rotation whereby the holder bar (12) can be utilised as a fixed grab bar.

2. Holder apparatus (10) as claimed in claim 1, wherein the holder bar (12) includes a plurality of axially extending flutes (28) in which the holder element (18) is slidably engaged.

3. Holder apparatus (10) as claimed in claim 1 or claim 2, wherein the controller (64) includes a control housing (52) engaged with the holder element (18) and a user control element (66) which extends from the control housing (52).

4. Holder apparatus (10) as claimed in claim 3, wherein the locking means (22) includes a plurality of interengagable teeth (46) within the control housing (52), the teeth (46), when engaged, preventing or limiting rotation of the holder bar (12).

5. Holder apparatus (10) as claimed in claim 4, wherein the teeth (46), when engaged, prevent or limit rotation of the user control element (66).

6. Holder apparatus (10) as claimed in any one of claims 3 to 5, wherein the controller (64) includes an upper cantilever arm (78) which biases the locking means (22) to a locked condition.

7. Holder apparatus (10) as claimed in any one of claims 3 to 6, wherein the control housing (52) includes a head element (48) therein for slidable engagement with a lower cantilever arm (80) of the controller (64), so as to prevent or limit lifting of the control housing (52).

8. Holder apparatus (10) as claimed in any one of the preceding claims, wherein the controller (64) includes biasing means (78) for biasing the locking means (22) to a locked condition.

9. Holder apparatus (10) as claimed in any one of claims 3 to 8, further comprising a lower wall mounting bracket (14) and a lower adapter (38) which is engagable with the lower bracket (14) and on which the control housing (52) is rotatably mountable.

10. Holder apparatus (10) as claimed in claim 9, wherein the adapter (38) includes a protruding head element (48) which is engagable with the controller (64).

11. Holder apparatus (10) as claimed in any one of the preceding claims, further comprising an upper wall mounting bracket (16) and an upper adapter (86) which is rotatably engagable with the upper bracket (16) and with which the holder bar (12) is engagable.

12. Holder apparatus (10) as claimed in claim 11, wherein the upper adapter (86) includes a biasing element (94) for preventing or limiting play between the upper adapter (86) and the upper bracket (16).

13. Holder apparatus (10) as claimed in any one of the preceding claims, wherein the holder bar (12) is adapted for use from a fixed grab rail.

14. Holder apparatus (10) as claimed in any one of the preceding claims, wherein the controller (64) includes a user operable lever (66), the lever (66) including at least one protrusion (68) at or adjacent to a free distal end to aid operation by a user with limited or no dexterity.

15. Holder apparatus (10) as claimed in any one of the preceding claims, further comprising a spacer element (110) which is engagable with the holder bar (12).

16. Holder apparatus (10) as claimed in claim 15, wherein the spacer element (110) includes an angled arm member (112) which is engagable with a lower wall mounting bracket (14), and a collar element (114) which is slidably receivable on the holder bar (12).

17. Holder apparatus (10) as claimed in claim 16, wherein the collar element (114) is releasably engagable with the arm member (112).

18. Holder apparatus (10) as claimed in claim 17, wherein the collar element (114) is reversible to change its position on the arm member (112).

19. Holder apparatus (10) as claimed in any one of the preceding claims, further comprising a showering-accessory support element (126) which is slidably receivable on the holder bar (12), the support element (24) being rotatable independently of the holder element (18).

20. Holder apparatus (10) as claimed in claim 19, wherein the support element (126) includes a platform element (130) for supporting a showering accessory thereon.

21. Holder apparatus (10) substantially as hereinbefore described with reference to the accompanying drawings.

22. A shower installation having holder apparatus (10) as claimed in any one of the preceding claims, and a shower head which is releasably engagable with the holder element (18) and remotely movable in at least a pan direction by the adjustment means (20) of the holder apparatus (10).

23. An installation having holder apparatus (10) as claimed in any one of claims 1 to 21, and an item which is holdable by the holder element (18) and remotely movable in at least a pan direction by the adjustment means (20) of the holder apparatus (10).
